(19) United States
(12) Patent Application Publication
(10) Pub. No.: US 2013/0161942 A1
(43) Pub. Date: Jun. 27, 2013

(54) CONNECTION FOR ROLL-BOND PANELS

(71) Applicant: Thesan S.p.A., Torino (IT)

(72) Inventor: Aimone BALBO DI VINADIO, Chiusan San Michele (Torino) (IT)

(73) Assignee: Thesan S.p.A., Torino (IT)

(21) Appl. No.: 13/722,610

(22) Filed: Dec. 20, 2012

(30) Foreign Application Priority Data
Dec. 21, 2011 (IT) TO2011A001182

(51) Int. Cl. F16L 41/08

(52) U.S. Cl. CPC F16L 41/08
USPC 285/125.1

(57) ABSTRACT

A connection device for a roll-bond heat exchanger comprising two sheets fixed together on opposite sides with respect to a central plane and a plurality of channels for circulation of a fluid that are formed between said sheets. The connection device comprises at least one pair of connectors in fluid communication with said channels, and each of said connectors is situated on just one side with respect to said central plane.

### CROSS-REFERENCE TO RELATED APPLICATIONS

This application claims benefit of Italian Patent Application No. TO2011A001182, filed Dec. 21, 2011, which is herein incorporated by reference.

### BACKGROUND OF THE INVENTION

1. Field of the Invention

The present invention regards the system of connection between two roll-bond panels or else between a roll-bond panel and a hydraulic system.

2. Description of the Related Art

Roll bonding is a process for obtaining panels provided with channels for circulation of a fluid. Roll-bond panels are produced using a technique of joining by rolling of a sandwich formed by two aluminium sheets. The paths and dimensions of the channels obtained on the panels thus made are determined by a pressing operation that is performed on one of the inner surfaces of the sandwich. The joining of the two inner surfaces of the sandwich is an autogenous weld obtained by combining heat (preheating of the sandwich) and pressure (hot rolling). Welding between the surfaces is not performed in areas where there is a special ink applied in the pressing step, thus determining paths of non-welded areas inside the sandwich. The non-welded areas can be raised by applying an inflation pressure that transforms the non-welded paths into channels. The panels thus obtained are completed with connectors.

A typical field of use of roll-bond panels is for the production of evaporators for refrigerating appliances (refrigerators and freezers) for domestic use. Roll-bond panels are also used as heat exchangers in heat-pump systems. Recently, roll-bond panels are also applied on the rear part of photovoltaic solar panels for cooling the photovoltaic cells.

In solutions of a conventional type, roll-bond panels are provided with connectors shaped like cylindrical tubes set between the two sheets of the panel. The cylindrical tubes forming the connectors are fixed to the panel by means of welding and project from the respective edge of the panel.

Connectors of a known type create difficulties for assembly of the photovoltaic panels provided with roll-bond cooling panels. In fact, connectors of a traditional type generate swellings in the area in which the connectors are applied. This is a problem also when the roll-bond panels are used as radiant elements that remain in view, in which case the swellings at the connectors create very evident aesthetic defects.

In addition, the connectors that project from the edges of the roll-bond panels do not allow the edges of two adjacent panels to be set against one another, a situation that is indispensable in the applications referred to above.

### SUMMARY OF THE INVENTION

The object of the present invention is to provide a system of connection for a roll-bond heat-exchanger panel that will overcome the drawbacks of known solutions.

According to the present invention, said object is achieved by a roll-bond panel having the characteristics forming the subject of Claim 1.

### BRIEF DESCRIPTION OF THE DRAWINGS

The present invention will now be described in detail with reference to the annexed drawings, which are provided purely by way of non-limiting example and in which:

FIG. 1 is a perspective view of a roll-bond panel according to the present invention;

FIG. 2 is a perspective view at a larger scale of the part indicated by the arrow II in FIG. 1;

FIG. 3 is a partially exploded perspective view of the portion of panel illustrated in FIG. 2;

FIG. 4 is a front view according to the arrow IV of FIG. 3;

FIG. 5 is a perspective view that illustrates two roll-bond panels according to the present invention butted together;

FIG. 6 is a cross section according to the line VI-VI of FIG. 5; and

FIGS. 7, 8 and 9 are perspective views illustrating alternative embodiments of the connectors used in a panel according to the present invention.

### DETAILED DESCRIPTION

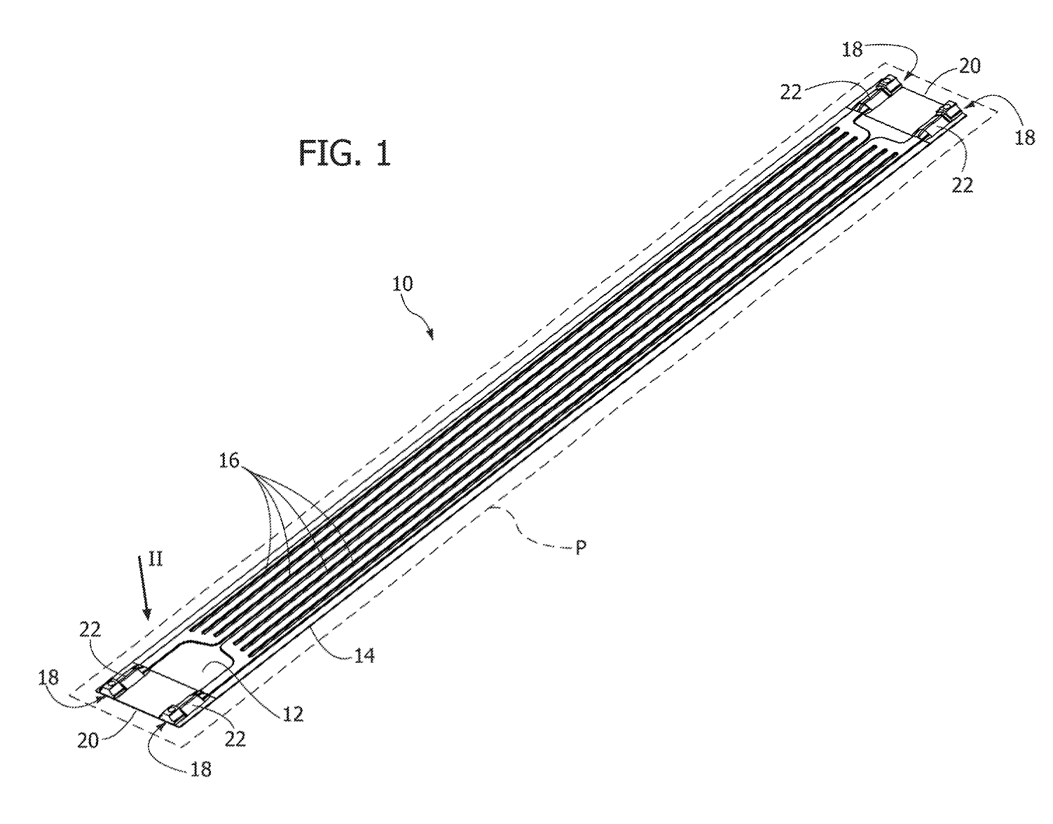

Designated by 10 in FIG. 1 is a roll-bond heat-exchanger panel according to the present invention. The roll-bond panel 10 illustrated in FIG. 1 has a narrow and elongated rectangular shape. This shape of panel has been devised for use in strip-shaped solar panels of the type described in the document No. EP2219228. The panel 10 comprises a first sheet 12 and a second sheet 14 fixed together on opposite sides with respect to a central plane P. The panel 10 comprises a plurality of channels 16 for circulation of a fluid, formed between the sheets 12, 14 by means of deformation of at least one of the sheets 12, 14. The present invention may be applied to roll-bond panels of any shape and structure.

The panel 10 comprises two pairs of connectors 18, in fluid communication with the channels 16, for inlet and outlet of the heat-exchange fluid. In the example illustrated, the connectors 18 are set at the minor sides 20 of the panel 16, but it is understood that the connectors 18 may be set at any point.

According to the present invention, each of the connectors 18 is set on just one side of the central plane P. In other words, the connectors 18 do not intersect the central plane P. The connectors 18 are fixed on the top surface of the first sheet 12 and are located with respect to the plane P on the same side of the sheet 12.

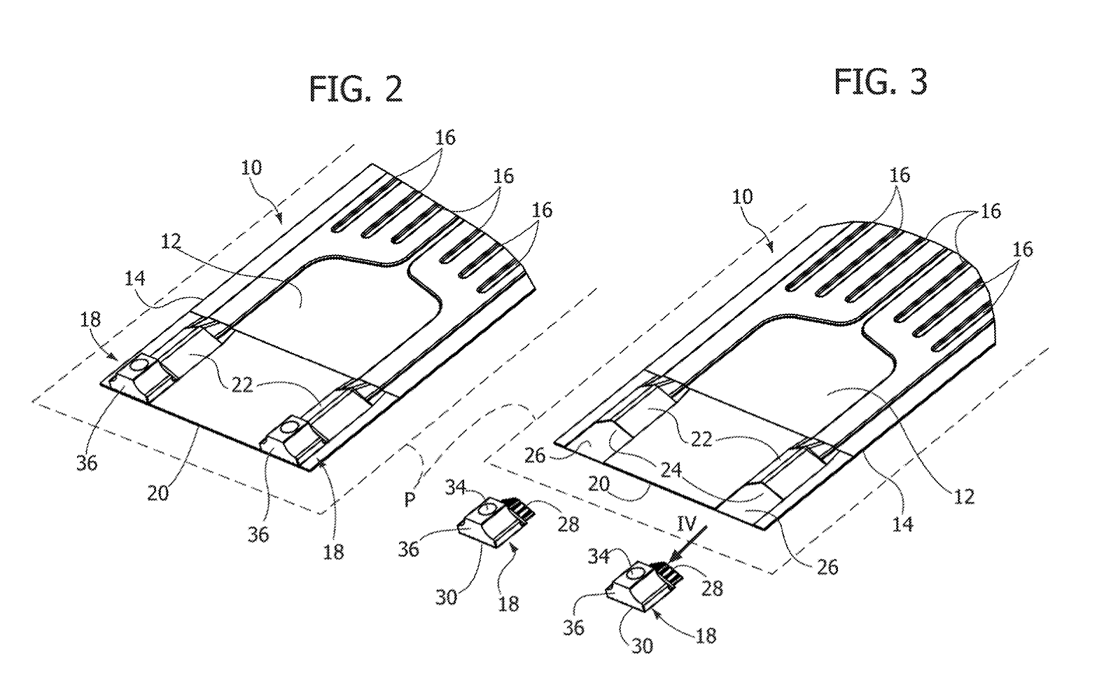

With reference to FIGS. 2 and 3, in the example illustrated the sheet 12 is provided in the vicinity of the minor sides 20 with protuberances 22 that project from the plane P. The protuberances 22 have an open front side 24. In the example illustrated, the protuberances 22 have a triangular shape. Provided underneath the protuberances 22 is a plane resting surface 26. The protuberances 22 define respective channels open at the front in fluid communication with the channels 16.

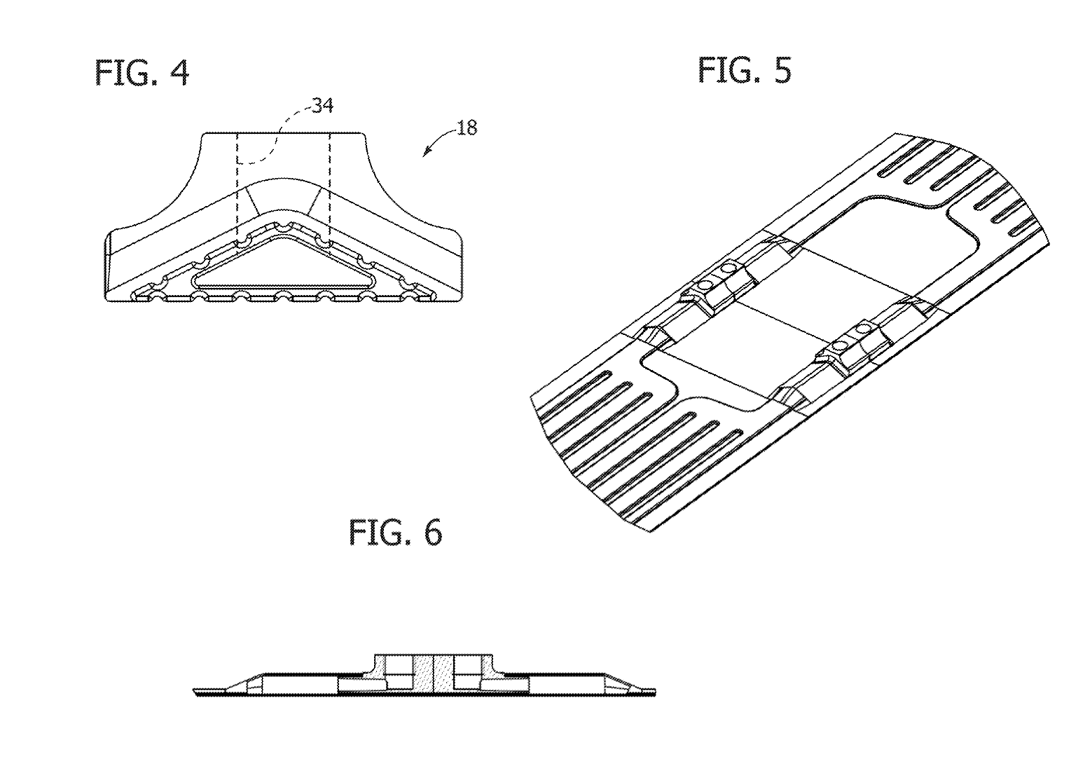

With reference to FIGS. 3 and 4, each connector 18 is preferably constituted by a body made of injection-moulded plastic material. Each connector 18 has a beak 28 that fits through the front opening 24 of the respective projection 22. The beak 28 establishes a shape fit with the inner walls of the respective projection 22. Each connector 18 has a plane base 30 that rests on the plane surface 26 of the panel 10. The connectors 18 are preferably fixed to the panel 10 by means of glue. As illustrated in FIG. 4, the outer surfaces of the beak 28 and the plane base 30 are preferably grooved so that the glue will grip better.

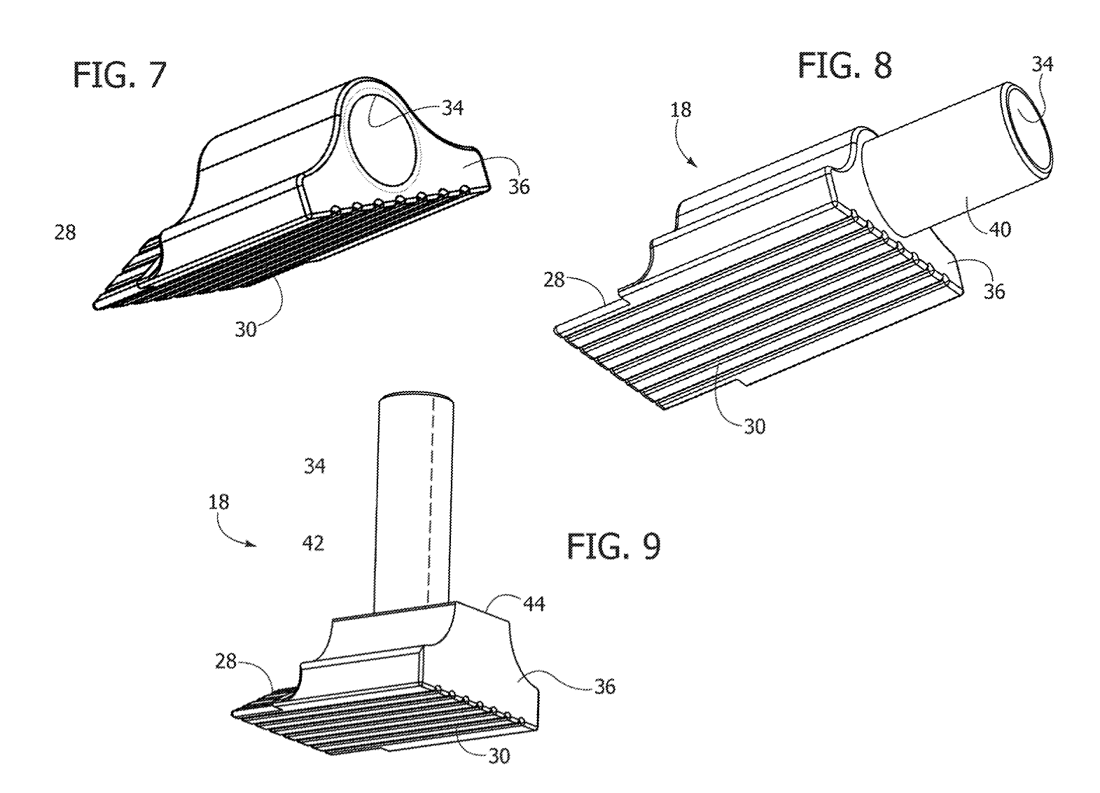

Each connector 18 has a first hole 32 formed within the beak 28 and a second hole 34 in communication with the first hole 32. The second hole 34 is to receive a complementary connector element (not illustrated) fixed, for example, at the end of a flexible tube. The second hole 34 can be threaded for receiving an externally threaded male connector element. As is illustrated in FIG. 2, the connectors 18 can be fixed to the panel 10 so that a front wall 36 of the connectors 18 will be flush with the respective minor side 20 of the panel 10. Alternatively, the connectors 18 can be shifted towards the inside of the panel. In the example illustrated in FIGS. 2, 3 and 4, the axis of the hole 34 is orthogonal to the axis of the hole 32. In the variant illustrated in FIG. 7, the hole 34 is open on the front surface 36 of the connector 18, and its axis is parallel to the axis of the hole 32. Illustrated in FIG. 8 is the case where the connector 18 is provided with a tubular appendage 40 that projects from the front surface 36 of the connector 18 and provided within which is the hole 34. In the further variant illustrated in FIG. 9, a tubular appendage 42 is provided, which projects from a top surface 44 of the body of the connector 18 and made in which is the hole 34.

As is illustrated in FIGS. 5 and 6, with the solution according to the present invention it is possible to have two panels 10 with the respective minor sides 20 in mutual contact. This arrangement is particularly advantageous in the case where the roll-bond panels 10 are applied to photovoltaic solar panels that are to be mounted in mutual contact and without leaving any discontinuity between adjacent panels or else in the case where the roll-bond panels are used as radiant panels in view.

The solution according to the present invention enables the wall of the panel opposite to the connectors 18 10 to be made perfectly plane. The wall opposite to the connectors 18 (in this case the wall formed by the sheet 14) is without bosses or swellings typical of connectors of a known type. This simplifies the operations of rolling during production of the photovoltaic solar panels. This characteristic also affords an aesthetic advantage in the case where the plane part of the panel is in view, as in the case of the roll-bond panels used as radiant panels in view.

The connectors 18 according to the present invention can also be assembled on the roll-bond panel 10 after the process of rolling of the photovoltaic solar panel. Fixing of the connectors 18 according to the invention by means of gluing, instead of welding according to the prior art, simplifies the operations of fixing of the connector.

The hydraulic connection between the adjacent panels is made without any spacing between the panels and maintaining surface continuity. The different types of connectors 18 enable hydraulic connection to be made in a direction orthogonal to or coplanar with the roll-bond panel according to the needs. The threaded-connection hole of the connectors 18 enables use of standard hydraulic connectors for hydraulic connection of the panels 10.

Of course, without prejudice to the principle of the invention, the details of construction and the embodiments may vary widely with respect to what has been described and illustrated herein, without thereby departing from the scope of the invention as defined by the ensuing claims.

1. A connection device for a roll-bond heat-exchanger panel comprising two sheets fixed together on opposite sides with respect to a central plane and a plurality of channels for circulation of a fluid that are formed between said sheets, the connection device comprising at least one pair of connectors in fluid communication with said channels, wherein each of said connectors is situated on just one side with respect to said central plane.

2. The connection device according to claim 1, wherein said first sheet is provided with protuberances projecting from said central plane and provided with front openings forming channels fitted within which are beak portions of said connectors.

3. The connection device according to claim 1, wherein said connectors are glued to the panel.

4. The connection device according to claim 1, wherein said connectors have respective front surfaces set flush with or at a distance, towards the inside of the panel, from a respective edge of the panel.

5. The connection device according to claim 2, wherein each of said connectors comprises a first hole in said beak portion and a second, threaded, hole.

6. The connection device according to claim 5, wherein the second hole has an axis parallel to the axis of the first hole.

7. The connection device according to claim 5, wherein the second hole has an axis orthogonal to the axis of the first hole.

8. The connection device according to claim 5, wherein the second hole is formed in a tubular appendage projecting from a front surface or top surface of the body of the connector.

9. The connection device according to claim 1, wherein said panel has a planar wall opposite to the surface on which said connectors are applied.
